(19) United States
(12) Patent Application Publication
(10) Pub. No.: US 2016/0165423 A1
(43) Pub. Date: Jun. 9, 2016

(54) APPLICATION SPECIFIC CONGESTION CONTROL MANAGEMENT

(71) Applicant: SONY CORPORATION, Minato-ku, Tokyo (JP)

(72) Inventors: Bo Larsson, Malmö (SE); Samir Drincic, Tokyo (JP); Saif Alnashi, Staffanstorp (SE)

(21) Appl. No.: 14/908,283

(22) PCT Filed: Oct. 16, 2013
(86) PCT No.: PCT/IB2013/002299

§ 371 Date: Jan. 28, 2016

(51) Int. Cl. H04W 4/22; H04W 12/06; H04W 12/08; H04L 12/24; H04W 76/00

(52) U.S. Cl. CPC H04W 4/22; H04L 41/0806; H04W 76/007; H04W 12/08; H04W 12/06; H04W 84/042

(57) ABSTRACT

In response to attaching to a mobile network, a user equipment (10) receives a provisioning message (207) from the mobile network. The provisioning message indicates a list of one or more applications which are allowed to perform data communication in a disaster situation. The user equipment (10) may authenticate the provisioning message (207) and then use the list for performing application specific congestion control.

The present invention relates to methods for management of application specific congestion control and to corresponding devices.

In disaster situations, there is a risk of congestions in a mobile network due to unusually large numbers of subscribers trying to communicate over the mobile network.

3GPP TR 22.806 V0.3—Study on Application Specific Congestion Control for Data Communication (ACDC)—discusses concepts for handling network congestion in disaster situations, for example, earthquakes. The basic idea is to grant network access of a user equipment (UE) only for specific applications when the network invokes the ACDC functionality by signalling “disaster” to the attached UEs. The allowed applications are determined by the network operator, and a list of these applications is provisioned to the UEs. In 3GPP TR 22.806, this list is referred to as “ACDC list”, “ACDC rule”, “ACDC category”, or “ACDC control”. In the following, the term “ACDC list” will be used.

However, in the case of ACDC, the home networks operator's ACDC list cannot be used when the UE is roaming since the visited network operator's ACDC list may be different (due to different policies). This implies that the UE needs to be provisioned by the visited network operator in a roaming scenario.

Since the ACDC list implies restrictions to the user, it is likely that some subscriber will try to manipulate the list in order to circumvent these restrictions. It is also possible that some subscribers may be subject to fraudulent provisioning data implying excessive restrictions.

Accordingly, there is a need for techniques which allow for providing the ACDC list reliably to a UE.

According to an embodiment of the invention, a method for application specific congestion control in a mobile network is provided. According to the method, a node of the mobile network sends a provisioning message to a UE. This is accomplished in response to detecting attachment of the UE to the mobile network. The provisioning message indicates a list of one or more applications which are allowed to perform data communication in a disaster situation. The list may in particular be an ACDC list as described in 3GPP TR 22.806.

According to an embodiment, the provisioning message is authenticable by the UE. In this case, a signed response from an authentication node of the mobile network may be used for authentication of the provisioning message. Such signed response may be generated on the basis of an authentication key of the UE, e.g., a key referred to as Ki, which is stored in the authentication node. An example of such authentication node is an Authentication Center (AuC) as provided by a Home Location Register (HLR) or Home Subscriber Server (HSS) of a 3GPP mobile network.

The node of the mobile network may obtain the signed response from the authentication node on the basis of at least one information element to be included into the provisioning message. Examples of such information elements are a download resource identifier to be used by the UE for obtaining the list, e.g., in the form of a Uniform Resource Identifier (URL), an Access Point Name (APN) to be used by the UE for obtaining the list, or some other identifier of the list, e.g., a hash value of the list which may be utilized for uniquely identifying a specific version of the list. Such hash value may for example be generated using a Secure Hash Algorithm (SHA), e.g., SHA-1, or a Message Digest (MD) algorithm, e.g., MD5. The node of the mobile network may then generate the provisioning message to include both the signed response and the at least one information element on the basis of which the signed response was generated.

Having received the provisioning message, the UE may use the same information element(s) to obtain a signed response from a subscriber identity module (SIM) of the UE, e.g., a SIM card, an embedded SIM, a Universal SIM (USIM), or a Universal Integrated Circuit Card (UICC). In response to a match of the signed response obtained from the SIM to the signed response received with the provisioning message, the UE may determine the provisioning message as authenticated and take further actions, e.g., obtain the list indicated in the provisioning message and/or activate the list. Otherwise, the UE may refrain from taking such actions.

To obtain the signed response, the node of the mobile network may also first generate a hash value of the at least one information element. The hash value may then be used as an input string of a given length, e.g., 128 bit, for obtaining the signed response. In this way, compatibility with the existing authentication mechanism of the mobile network may be achieved.

According to an embodiment, the node of the mobile network may also generate a random number and obtain a signed response from the authentication node on the basis of the random number. The node may then generate the provisioning message to include an encrypted part, which is encrypted using the signed response as key, and an unencrypted part including the random number.

According to a further embodiment of the invention, a method for application specific congestion control in a mobile network is provided. According to the method, a UE receives a provisioning message from the mobile network, e.g., from the above-mentioned node of the mobile network. This is accomplished in response to the UE attaching to the mobile network. The provisioning message indicates a list of one or more applications which are allowed to perform data communication in a disaster situation, e.g., an ACDC list.

According to an embodiment, the UE authenticates the provisioning message. This may be accomplished on the basis of a signed response included in the provisioning message and a signed response obtained from a SIM of the UE, e.g., a SIM card, an embedded SIM, a USIM, or a UICC. Such signed response may be generated on the basis of an authentication key of the UE, e.g., a key referred to as Ki, which is stored in the SIM. Specifically, on the basis of at least one information element included in the provisioning message, the UE may obtain a signed response from the SIM. Examples of such information elements are a download resource identifier to be used by the UE for obtaining the list, e.g., in the form of a URL, an APN to be used by the UE for obtaining the list, or some other identifier of the list, e.g., a hash value of the list which may be utilized for uniquely identifying a specific version of the list. Such hash value may for example be generated using an SHA, e.g., SHA-1, or a MD algorithm, e.g., MD5.

In response to a match of this signed response to the signed response in the provisioning message, the UE may determine the provisioning message as authenticated. The UE may then take further actions, e.g., obtaining the list indicated in the provisioning message, e.g., using a download resource identifier and/or APN indicated in the provisioning message, and/or activating the list. Otherwise, the UE may refrain from taking such actions.

To obtain the signed response, the UE may also first generate a hash value of the at least one information element. The hash value may then be used as an input string of a given length, e.g., 128 bit, for obtaining the signed response. In this way, compatibility with the existing authentication mechanism of the mobile network may be achieved.

According to an embodiment, the UE may also obtain a random number from an unencrypted part of the provisioning message and use this random number as the basis for obtaining a signed response from the SIM. Using this signed response as key, the UE may then decrypt an encrypted part of the provisioning message.

As mentioned above, the provisioning message may include an identifier of the list, e.g., a hash value which may be used for uniquely identifying a specific version of the list. On the basis of the hash value, the UE may determine whether the list is already stored on the UE. In this way, multiple download operations of the same list may be avoided, allowing for efficient resource usage.

According to some embodiments of the above methods, the provisioning message may also include a standardized APN to be used for obtaining the list. Such standardized APN may be specified by a standard of a communication technology utilized by the mobile network. Such standardized APN may point to a trusted PDN (Packet Data Network) for obtaining the list, e.g., a PDN hosted by the mobile network operator, and thereby ensure reliable provisioning of the list even without explicit authentication of the provisioning message.

According to a further embodiment of the invention, a node for a mobile network is provided. The node comprises an interface for communication with a UE. Further, the node comprises a processor. The processor is configured to send, in response to detecting attachment of the UE to the mobile network, a provisioning message UE. The provisioning message indicates a list of one or more applications which are allowed to perform data communication in a disaster situation, e.g., an ACDC list. The processor may be configured to perform steps of the above method, which are to be performed by the node of the mobile network. In particular, the processor may be configured to obtain, on the basis of at least one information element to be included into the provisioning message, the signed response from the authentication node of the mobile network, and generate the provisioning message to include the at least one information element and the signed response. Further, the processor may be configured to generate the hash value from the at least one information element and obtain the signed response on the basis of the hash value. Further, the processor may be configured to generate the random number, on the basis of the random number, obtain the signed response from the authentication node of the mobile network, and generate the provisioning message to include an encrypted part which is encrypted using the signed response as key, and an unencrypted part including the random number.

According to a further embodiment of the invention, a UE is provided. The UE comprises an interface for connecting to a mobile network. Further, the UE comprises a processor. The processor is configured to receive, in response to the UE attaching to the mobile network, a provisioning message from the mobile network. The provisioning message indicates a list of one or more applications which are allowed to perform data communication in a disaster situation, e.g., an ACDC list. The processor may be configured to perform steps of the above method which are to be performed by the UE. In particular, the processor may be configured to authenticate the provisioning message. Further, the processor may be configured to obtain, on the basis of the at least one information element included in the provisioning message, the signed response from the SIM, and in response to a match of the obtained signed response to a signed response in the provisioning message, determine the provisioning message as authenticated. Further, the processor may be configured to generate the hash value from the at least one information element, and obtain the signed response on the basis of the hash value. Further, the processor may be configured to obtain the random number from the unencrypted part of the provisioning message, obtain the signed response from the SIM of the UE on the basis of the random number, and decrypt the encrypted part of the provisioning message using the signed response as key. Further, the processor may be configured to obtain, on the basis of the download resource identifier, the list from a server. Further, if the provisioning message comprises a hash value of the list, the processor may be configured to determine, on the basis of the hash value, whether the list is already stored on the UE.

Although specific features described in the above summary and in the following detailed description are described in connection with specific embodiments and aspects, it is to be understood that the features of the embodiments and aspects may be combined with each other unless specifically noted otherwise.

Embodiments of the invention will now be described in more detail with reference to the accompanying drawings.

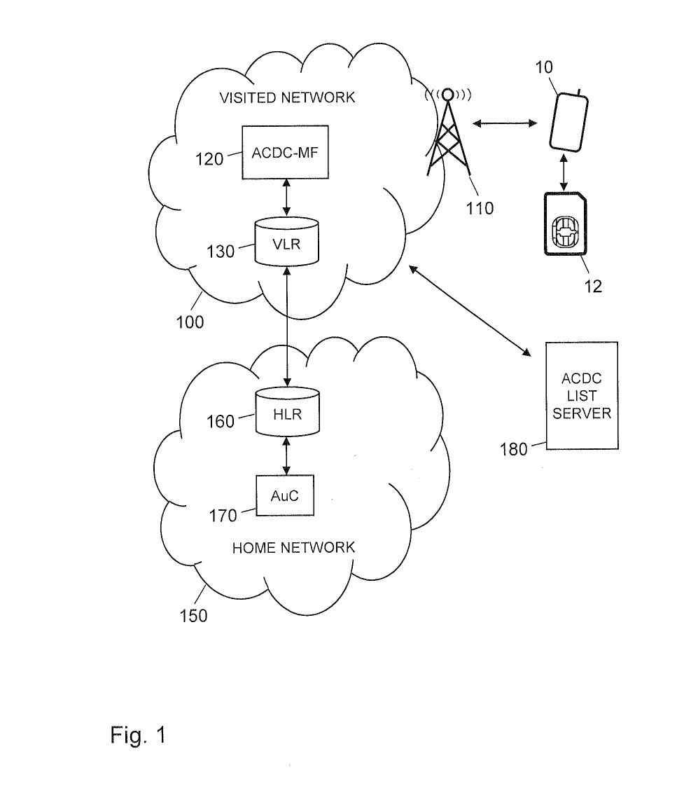

FIG. 1 schematically illustrates a network architecture which may be used for ACDC list provisioning according to an embodiment of the invention.

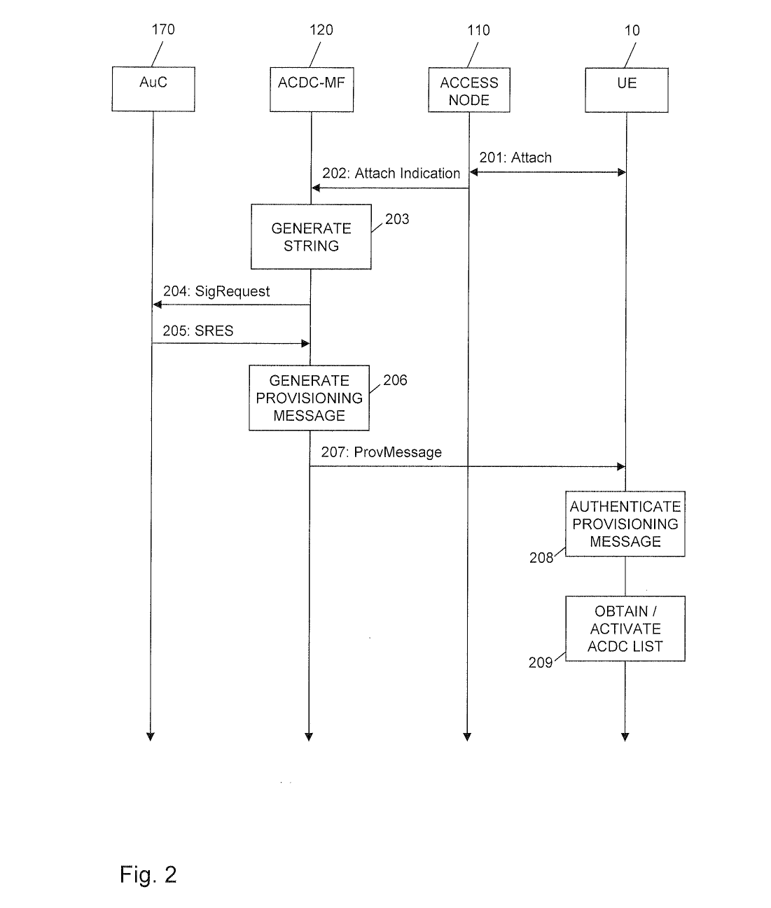

FIG. 2 shows a signalling diagram for illustrating an exemplary ACDC list provisioning process according to an embodiment of the invention.

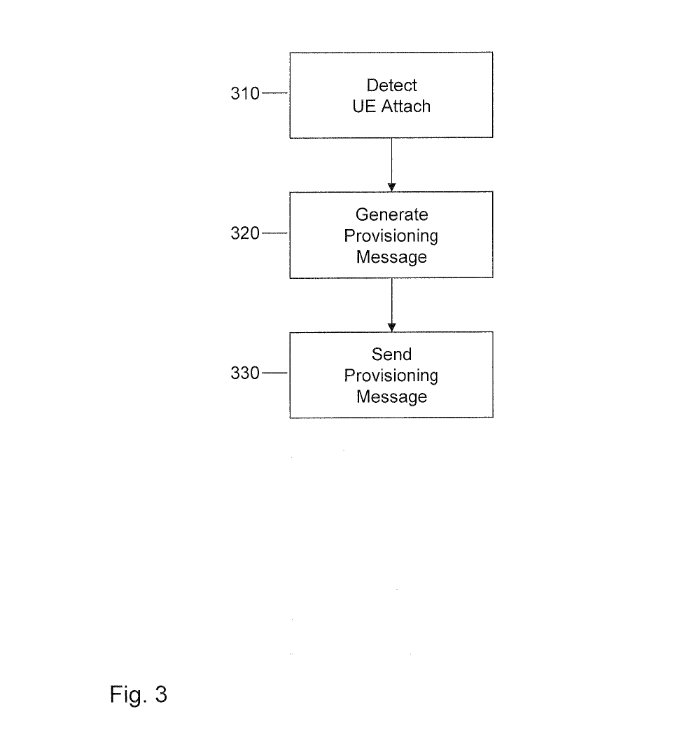

FIG. 3 shows a flowchart for illustrating a method according to an embodiment of the invention.

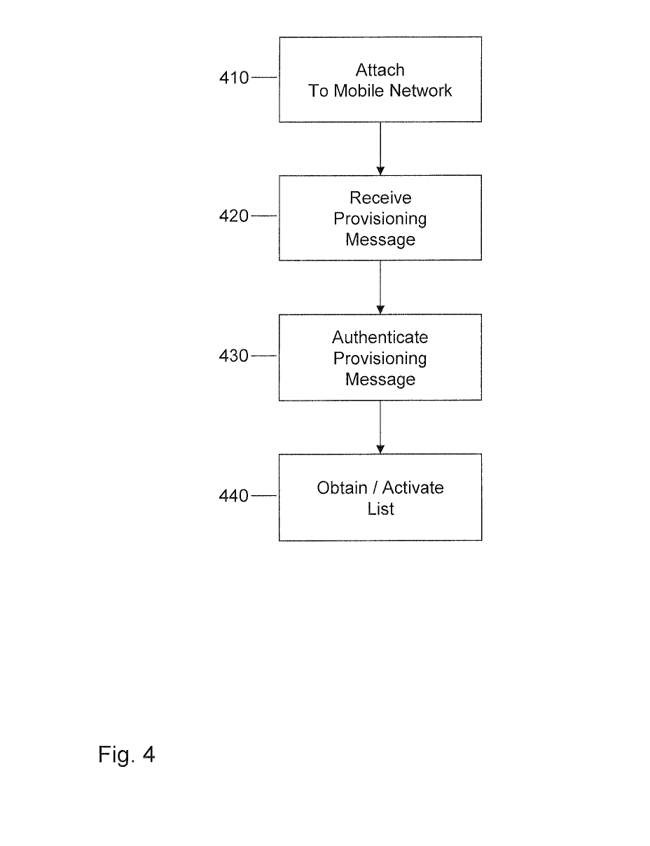

FIG. 4 shows a flowchart for illustrating a method according to a further embodiment of the invention.

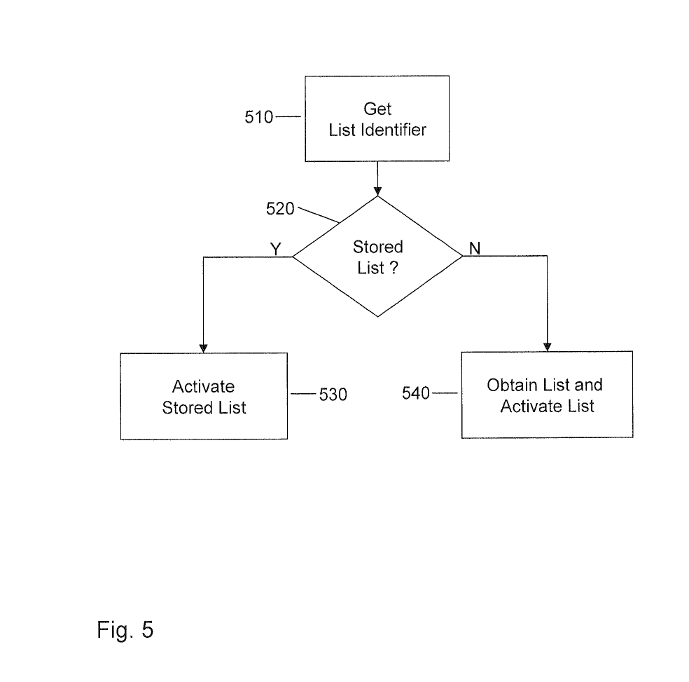

FIG. 5 shows a flowchart for illustrating a method according to a further embodiment of the invention.

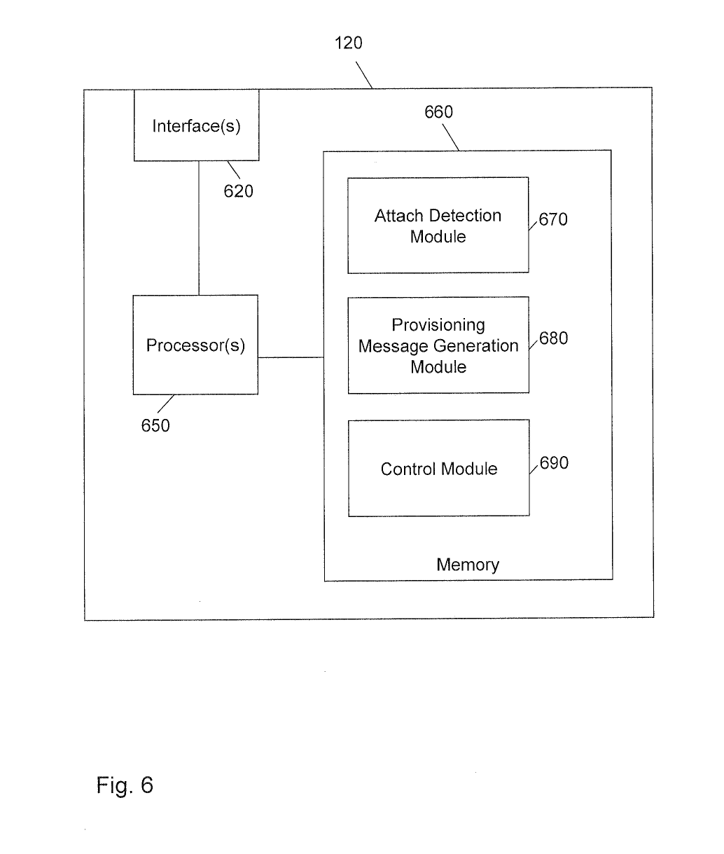

FIG. 6 schematically illustrates network node according to an embodiment of the invention.

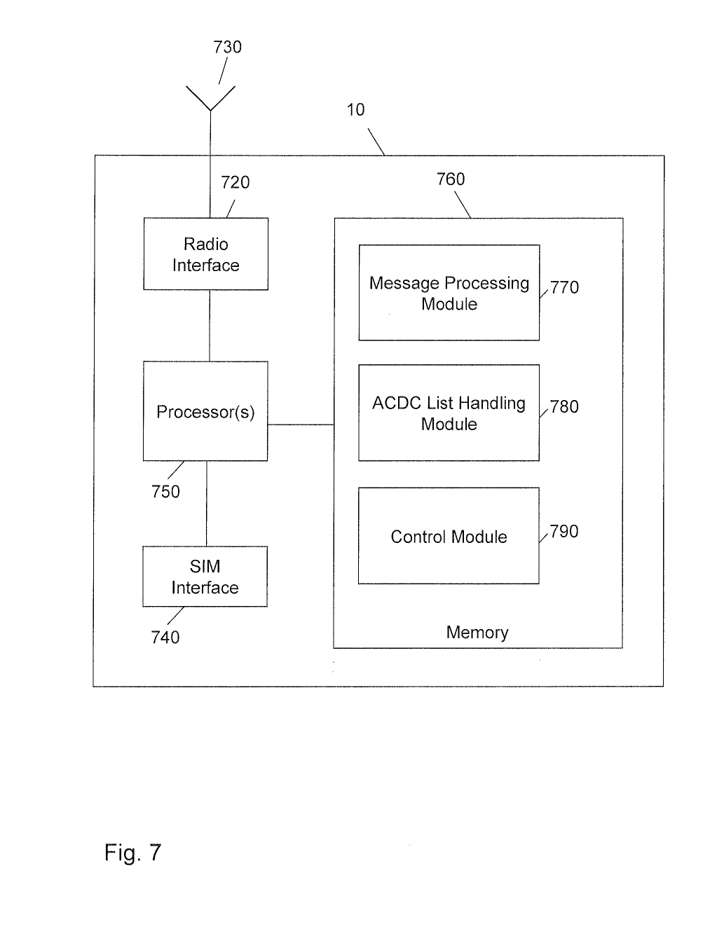

FIG. 7 schematically illustrates a UE according to an embodiment of the invention.

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments hereinafter.

The illustrated embodiments relate to methods and devices which allow for efficiently and reliably managing application specific congestion control by provisioning an ACDC list to a UE. The UE may be a mobile phone, a smartphone, a tablet computer, a laptop computer, an MDA, or the like. Further, the UE may support communication over various network technologies. This may include cellular radio access technologies such as Global System for Mobile Communications (GSM), Code Division Multiple Access (CDMA) based cellular radio access technologies such as Universal Mobile Telecommunications System (UMTS), Wideband-CDMA, or CDMA2000, or the LTE (Long Term Evolution) cellular radio access technology specified by the 3^{rd} Generation Partnership Project (3GPP). Further, the UE may also support other wireless access technologies, such as Wireless Local Area Network (WLAN) or WiMAX (Worldwide Interoperability for Microwave Access). Further, also wire-based accesses may be supported.

FIG. 1 schematically illustrates a mobile network architecture which may be used for ACDC list provisioning according to an embodiment of the invention. In the illustrated example, it is assumed that a UE 10 is roaming in a visited network 100. Further, FIG. 1 illustrates a home network 150 of the UE 10. The visited network 100 and the home network 150 may each correspond to a Public Land Mobile Network (PLMN).

In the illustrated scenario, the UE 10 is roaming in the visited network 100, i.e., is connected to an access node 110 of the visited network 100. The access node 110 may for example be a base station, e.g., a GSM Radio Base Station, a UMTS Node B, or an LTE eNB. The access node 110 may also be a control node of an access network, e.g., a GSM Base Station Controller (BSC) or an UMTS Radio Network Controller (RNC). When roaming in the visited network 100, the UE 10 is authenticated by interaction between the visited network 100 and the home network 150, which includes a subscriber database with access to an authentication key of the UE 10. In the illustrated example, the subscriber database is assumed to be a HLR 160 as specified for the GSM radio technology. However, it is to be understood that other types of subscriber database could be utilized as well, e.g., a HSS, a Subscriber Data Repository (SDR), or a User Data Repository (UDR). In the illustrated example, the authentication key is assumed to be maintained by an Authentication Center (AuC) 170, which may be a subcomponent of the HLR 160. The same authentication key is also stored in a SIM 12 of the UE 10. As illustrated, the SIM 12 may be an interchangeable SIM card which is inserted to the UE 10 to make the UE 10 useable through the subscription of a certain user with the operator of the home network 150. Alternatively, also another type of smartcard with SIM functionality could be used, e.g., a USIM or UICC. Further, the SIM 12 could also be an embedded component of the UE 10, which is not interchangeable. The authentication key is also referred to as Ki.

Authentication of the UE 10 roaming in the visited network may be accomplished by a node of the visited network, e.g., an Authorization, Authentication, and Accounting (AAA) node (not illustrated in FIG. 1), sending a random number (RAND) to the UE 10 which then responds with a signed response (SRES). The UE 10 may obtain the SRES from the SIM 12, where it is generated on the basis of the stored authentication key and the RAND. The SRES is generated on the basis of the authentication key stored in the SIM 12. This node may then obtain a further SRES from the AuC 170 in the home network 150 of the UE 10. In the illustrated example, this may be accomplished via a Visited Location Register (VLR) 130 in the visited network 100 and the HLR 160 in the home network 150. The UE 10 may then be authenticated by comparing the SRES from the UE 10 to the SRES from AuC 170 in the home network 100.

For the purpose of provisioning the ACDC list, the illustrated architecture further comprises an ACDC management function (ACDC-MF) 120 in the visited network 100 and an ACDC list server 180. The ACDC list server 180 may be a server which is accessible over a PDN. The PDN may be a network hosted by the mobile network operator and include the ACDC list server 180, or the PDN may provide connection to the Internet, and the ACDC list server 180 may be accessible using suitable Internet Protocol (IP) based mechanisms. The ACDC list server 180 stores one or more ACDC lists to be provided to UEs. The ACDC-MF 120 initiates provisioning of one of such ACDC lists to the UE 10. As explained in further detail below, this is accomplished in response to the UE 10 attaching to the visited network 100.

An exemplary ACDC list provisioning process is illustrated in FIG. 2. The process of FIG. 2 involves the UE 10, the access node 110, the ACDC-MF 120, and the authentication node 170.

The ACDC list provisioning process of FIG. 2 is initiated by the UE 10 attaching to the visited network 100, as illustrated by messages 201 transmitted between the access node 110 and the UE 10. Messages 201 may for example have the purpose of authenticating the UE 10. In the process of FIG. 2, it is assumed that the UE 10 is successfully authenticated and attaches to the visited network 100.

The access node 110 indicates attachment of the UE 10 to the ACDC-MF 120, as indicated by message 202. Although message 202 is illustrated as being directly sent from the access node 110 to the ACDC-MF 120, it should be understood that one or more further nodes may be involved in providing the indication of attachment to the ACDC-MF 120, but not illustrated in FIG. 1. For example, a node in the mobile network could monitor activity of the VLR or some other node which interacts with the access node 110 during attachment, to detect the attachment of the UE 10. The ACDC-MF 120 uses the message 202 to detect that the UE 10 has attached to the visited network 100. The message 202 may for example indicate an identity associated with the subscription of the UE 10, e.g., an International Mobile Subscriber Identity (IMSI) or Mobile Subscriber Integrated Services Digital Network Number (MSISDN).

The ACDC-MF 120 then determines the ACDC list to be sent to the UE 10. This may involve selecting the list from a set of lists stored on the ACDC list server 180. Specifically, the ACDC-MF 120 may determine a URL which can be used for obtaining the ACDC list from the ACDC list server 180. Further, the ACDC-MF 120 may determine an APN to be used for obtaining the ACDC list from the ACDC list server 180. The APN may help to ensure a specific way of charging when the UE 10 accesses the ACDC list server 180 to obtain the ACDC list. For example, such accesses may be excluded from charging.

Still further, the ACDC-MF 120 may determine a hash value of the ACDC list to be provisioned to the UE 10, e.g., using the SHA-1 or MD5 algorithm.

From one or more of the above mentioned information elements, i.e., the URL, the APN, and the hash value, the ACDC-MF 120 generates a string, as indicated by step 203. The string may for example be generated by concatenating the information elements and then generating a hash value of the concatenated information elements, thereby obtaining a string of a certain length which is compatible with the authentication mechanism of the mobile network. For example, a string length of 128 bit could be used for an authentication mechanism of the GSM technology.

Using the string as input parameter, the ACDC-MF 120 then requests a signed response from the AuC 170, as indicated by signature request (SigRequest) 204. The AuC 170 responds by sending a SRES 205 to the ACDC-MF 120. The interaction between the ACDC-MF 120 and the AuC 170 takes place via the VLR 130 and the HLR 140 (not illustrated in FIG. 2).

Having received the SRES 205, the ACDC-MF 120 generates a provisioning message, as illustrated by step 206. The provisioning message is generated to include the above-mentioned information elements, i.e., URL, APN, and hash value, and also the SRES 205. The ACDC-MF 120 then sends the provisioning message (ProvMessage) 207 to the UE 10. For example, the provisioning message 207 can be sent as a Short Message Service (SMS) message. Further, also other mechanisms may be used for sending the provisioning message 207, e.g.,as a Wireless Application Protocol (WAP) push message, an Open Mobile Alliance (OMA) Push message, a Session Initiation Protocol (SIP) message, or an IP Multimedia Subsystem (IMS) message.

In some implementations, the provisioning message may also be encrypted. For the latter purpose, a temporary key may be used, which may be obtained by using a random number (salt) as input string when obtaining a further SRES from the AuC 170. To allow decryption of the provisioning message, the provisioning message 207 may include the random number in unencrypted form. That is to say, the provisioning message 207 may be generated to include an unencrypted part with the random number and an encrypted part with other information elements, e.g., the URL, the APN, and the hash value.

Having received the provisioning message 207, the UE 10 may proceed by authenticating the provisioning message 207. For this purpose, the UE 10 obtains a further SRES from the SIM 12, using the same information elements as used by the ACDC-MF 120 for obtaining the SRES 205. Accordingly, the UE 10 gets these information elements from the provisioning message 207 and applies the same steps to generate a string as applied by the ACDC-MF 120 in step 203. This string is then used as input parameter for obtaining the further SRES from the SIM 12. The UE 10 may then authenticate the provisioning message 207 by comparing the SRES 205 in the provisioning message 207 to the further SRES from the SIM 12. In response to a match between the SRES 205 and the further SRES, the UE 10 may determine the provisioning message as authenticated. The UE 10 may then proceed by taking further actions to obtain the ACDC list from the ACDC list server 180 and/or to activate the ACDC list, as indicated by step 209.

Having activated the ACDC list, the UE 10 may operate by allowing network access only to applications in the ACDC list when the mobile network invokes the ACDC functionality by signalling disaster to the UE 10.

FIG. 3 shows a flowchart for illustrating a method according to an embodiment of the invention, which may be used to implement the above concepts in a node of a mobile network, e.g., in the ACDC-MF 120.

At step 310, the node detects that a UE attaches to the mobile network. This may be accomplished by receiving a corresponding indication from a node of the mobile network to which the UE connects, such as by message 202. As explained above, the UE may be roaming, i.e., attach to a visited network.

At step 320, the node generates a provisioning message. The provisioning message indicates a list of one or more applications which are allowed to perform data communication in a disaster situation. The list may in particular be an ACDC list. Information elements in the list may include a download resource identifier to be used for obtaining the list, an APN to be used for obtaining the list, and/or a hash value of the list, e.g., generated by the SHA-1 or MD5 algorithm, or some other identifier of the list.

In some implementations, the provisioning message may be authenticable. For this purpose, the provisioning message may include a SRES from an authentication node. The node may generate a string from one or more information elements to be included into the provisioning message and use this string as input parameter for obtaining the SRES from the authentication node.

In some implementations, the node may also generate a random number and obtain a SRES from the authentication node on the basis of the random number. The node may then generate the provisioning message to include an encrypted part, which is encrypted using the SRES as key, and an unencrypted part including the random number.

At step 330, the node sends the provisioning message to the UE. For example, the node may send the provisioning message as an SMS message. Further, also other mechanisms may be used for sending the provisioning message. For example, the provisioning message could be sent as a WAP push message, an OMA Push message, a SIP message, or an IMS message.

FIG. 4 shows a flowchart for illustrating a method according to an embodiment of the invention, which may be used to implement the above concepts in a UE, e.g., in the UE 10.

At step 410, the UE attaches to a mobile network. As explained above, the UE may be roaming, i.e., attach to a visited network.

At step 420, the UE receives a provisioning message from the mobile network. For example, the UE may receive the provisioning message as an SMS message. Further, the provisioning message could also be sent as a WAP push message, an OMA Push message, a SIP message, or an IMS message. The provisioning message indicates a list of one or more applications which are allowed to perform data communication in a disaster situation. The list may in particular be an ACDC list. Information elements in the list may include a download resource identifier to be used for obtaining the list, an APN to be used for obtaining the list, and/or a hash value of the list, e.g., generated by the SHA-1 or MD5 algorithm, or some other identifier of the list.

In some implementations, the UE may also obtain a random number from an unencrypted part of the provisioning message and use this random number as the basis for obtaining a SRES from the SIM. Using this SRES as key, the UE may then decrypt an encrypted part of the provisioning message.

At step 430, the UE 430 authenticates the provisioning message. For this purpose, the UE may generate a string from one or more information elements in the provisioning message and use this string to obtain a SRES from a SIM of the UE. Generating the string may also involve generating a hash value from the information elements. The UE may then authenticate the provisioning message by comparing the SRES from the SIM to a SRES in the provisioning message.

At step 440, the UE obtains and/or activates the list. For this purpose, the UE may download the list from a server, using a download resource identifier, e.g., URL, indicated in the provisioning message and/or using an APN indicated in the provisioning message. Having activated the list, the UE may operate to allow access to the mobile network only to applications indicated in the list.

It is to be understood that the methods of FIGS. 3 and 4 may be used in combination. In particular, the method of FIG. 3 may be used to provide the provisioning message which is received in the method of FIG. 4.

FIG. 5 shows a flowchart for illustrating a method according to an embodiment of the invention, which may be used to for efficiently implementing downloading of the list to the UE, e.g., in response to authenticating the provisioning message in the method of FIG. 4.

At step 510, the UE gets an identifier of the list from the provisioning message. The identifier may for example be a hash value of the list, e.g., generated by the SHA-1 or MD5 algorithm,

At step 520, the UE uses the identifier to check whether the list is already stored on the UE. For this purpose, the UE may compare the identifier to identifiers of lists which are stored in the UE. If the list is found to be already stored in the UE, the method proceeds to step 530, as indicated by branch “Y”. If the list is found to be not yet stored in the UE, the method proceeds to step 540, as indicated by branch “N”.

At step 530, the UE activates the stored list, omitting further steps of downloading the list and thereby avoiding unnecessary resource usage. A previously used list may be kept in the memory of the UE.

At step 540, the UE obtains the list from the server and then activates the obtained list. An obtained list and its identifier may be kept in the memory of the UE.

FIG. 6 schematically illustrates a exemplary structures of a network node for implementing the ACDC-MF 120.

In the illustrated implementation, the network node 120 is provided with one or more interfaces 620 which allow for connecting the network node 120 to one or more UEs, e.g., to the UE 10. The interfaces 620 may for example support sending SMS messages, WAP push messages, OMA Push messages, SIP messages, and/or IMS messages to the UEs. Further, the interfaces 620 may support communication with other nodes of the mobile network, e.g., with an authentication node such as the AuC 170.

Further, the network node 120 is provided with one or more processors 650 coupled to the interface(s) 620 and a memory 660 coupled to the processor(s) 650. The memory 660 may include suitable types of non-volatile and/or volatile memory, e.g., Random Access Memory (RAM), Read-Only-Memory (ROM), flash memory, or magnetic storage. The memory 660 may include data and/or program code to be used by the processor 650 for implementing the above-described functionalities of the ACDC-MF 120.

In particular, the memory 660 may include an attach detection module 670 with program code to be executed by the processor(s) 650 for implementing the functionalities for detecting attachment of the UE 10, e.g., by receiving a corresponding indication from a further node of the mobile network.

Further, the memory 660 may also include a provisioning message generation module 680 for implementing the above-described functionalities for generating the provisioning message, in particular rendering the provisioning message authenticable by obtaining and including the signed response from the authentication node.

Still further, the memory 660 may include a control module 690 with program code for implementing generic control functionalities of the network node 120, e.g., controlling the interface(s) 620 or other functionalities of the network node 120.

It is to be understood that the illustration of FIG. 6 is merely schematic and that the device 120 may include other components which have not been illustrated, e.g., further interfaces, one or more additional processors, or known components of a network node.

FIG. 7 schematically illustrates a exemplary structures for implementation of the UE 10.

In the illustrated implementation, the UE 10 is provided with a radio interface 720 which allows for connecting the UE 10 to a network. The radio interface 720 may be used for sending and receiving data via one or more antennas 730 of the UE 10. For example, the radio interface 720 may support one or more of the above-mentioned wireless access technologies, e.g., GSM, UMTS, Wideband-CDMA, CDMA2000, LTE, WLAN, or WiMAX. In addition, the interface 720 may support IP based packet data connections. As further illustrated, the UE 10 may be provided with a SIM interface 740. The SIM interface 740 may be used for coupling the UE 10 to a SIM, e.g., to a SIM card or UICC. In some implementations the UE 10 may also include an embedded SIM, which means that the SIM interface 740 would be an internal interface of the UE 10.

Further, the UE 10 is provided with one or more processors 750 coupled to the radio interface 720 and SIM interface 740. In addition, the UE 10 is provided with a memory 760 coupled to the processor(s) 750. The memory 760 may include suitable types of non-volatile and/or volatile memory, e.g., RAM, ROM, flash memory, or magnetic storage. The memory 760 may include data and/or program code to be used by the processor 750 for implementing the above-described functionalities of the UE 10.

In particular, the memory 760 may include a message processing module 770 with program code to be executed by the processor(s) 750 for implementing processing of the provisioning message as explained above, e.g., by performing authentication using the signed response in the provisioning message and the signed response from the SIM 12. Further, the memory 760 may include an ACDC list handling module 760 for implementing the above-described functionalities of obtaining or activating a particular ACDC list. Still further, the memory 760 may include a control module 790 with program code for implementing generic control functionalities of the UE 10, e.g., controlling the radio interface 720 or SIM interface, or controlling allowance of data access of specific application in accordance with the ACDC list.

It is to be understood that the illustration of FIG. 7 is merely schematic and that the UE 10 may include other components which have not been illustrated, e.g., further interfaces or one or more additional processors or other known components of a UE.

As can be seen, the concepts as explained above may be used to reliably provision an ACDC list to a UE. The concepts ensure that the provisioning process is initiated immediately when the UE attaches to the mobile network. Further, only trusted nodes can initiate the process.

It is to be understood that the concepts as explained above are susceptible to various modifications. For example, the concepts could be applied not only when the UE attaches to a visited network, but also when the UE attaches to its home network.

Further, in some embodiments a standardized APN for obtaining the ACDC list could be indicated in the provisioning message. A number of operators may thus use the same APN to access a source of the ACDC list, which provides additional reliability. In such cases, it is also possible to omit further authentication of the provisioning message.

Further, the concepts could be implemented using different hardware structures than illustrated in FIGS. 6 and 7. For example, rather than using software code executed by one or more processors, at least some of the illustrated functionalities could be implemented by dedicated hardware.

1. A method for application specific congestion control in a mobile network, the method comprising:
in response to detecting attachment of a user equipment to the mobile network, a node of the mobile network sending a provisioning message to the user equipment;
wherein the provisioning message indicates a list of one or more applications which are allowed to perform data communication in a disaster situation.

2. The method according to claim 1,
wherein the provisioning message is authenticable by the user equipment.

3. The method according to claim 2, comprising:
on the basis of at least one information element to be included into the provisioning message, the node obtaining a signed response from an authentication node of the mobile network; and
the node generating the provisioning message to include the at least one information element and the signed response.

4. The method according to claim 3, comprising:
the node generating a hash value from the at least one information element; and
the node obtaining the signed response on the basis of the hash value.

5. The method according to claim 1, comprising:
the node generating a random number;
on the basis of the random number, the node obtaining a signed response from an authentication node of the mobile network; and
the node generating the provisioning message to include an encrypted part which is encrypted using the signed response as key, and an unencrypted part including the random number.

6. The method according to claim 3,
wherein the signed response is based on an authentication key of the user equipment.

7. The method according to claim 1,
wherein the provisioning message comprises an identifier of the list.

8. The method according to claim 1,
wherein the provisioning message comprises a hash value of the list.

9. The method according to claim 1,
wherein the provisioning message comprises an Access Point Name to be used by the user equipment for obtaining the list.

10. The method according to claim 9,
wherein the Access Point Name is specified by a standard of a communication technology utilized by the mobile network.

11. A method for application specific congestion control in a mobile network, the method comprising:
in response to attaching to the mobile network, a user equipment receiving a provisioning message from the mobile network;
wherein the provisioning message indicates a list of one or more applications which are allowed to perform data communication in a disaster situation.

12. The method according to claim 11, comprising:
the user equipment authenticating the provisioning message.

13. The method according to claim 12, comprising:
on the basis of at least one information element included in the provisioning message, the user equipment obtaining a signed response from a subscriber identity module of the user equipment; and
in response to a match of the obtained signed response to a signed response in the provisioning message, the user equipment determining the provisioning message as authenticated.

14. The method according to claim 13, comprising:
the user equipment generating a hash value from the at least one information element; and
the user equipment obtaining the signed response on the basis of the hash value.

15. The method according to claim 11, comprising:
the user equipment obtaining a random number from an unencrypted part of the provisioning message;
on the basis of the random number, the user equipment obtaining a signed response from a subscriber identity module of the user equipment; and
using the signed response as key, the user equipment decrypting an encrypted part of the provisioning message.

16. The method according to claim 13,
wherein the signed response is based on an authentication key stored in the subscriber identity module.

17. The method according to claim 11, wherein the provisioning message comprises a download resource identifier of the list.

18. The method according to claim 17, comprising:
on the basis of the download resource identifier, the user equipment obtaining the list from a server.

19. The method according to claim 11,
wherein the provisioning message comprises a hash value of the list.

20. The method according to claim 19, comprising:
on the basis of the hash value, the user equipment determining whether the list is already stored on the user equipment.

21. The method according to claim 11,
wherein the provisioning message comprises an Access Point Name to be used by the user equipment for obtaining the list.

22. The method according to claim 21,
wherein the Access Point Name is specified by a standard of a communication technology used for implementing the mobile network.

23. A node for a mobile network, the node comprising:
an interface for communication with a user equipment; and
a processor, the processor being configured to:
in response to detecting attachment of the user equipment to the mobile network, send a provisioning message to the user equipment;
wherein the provisioning message indicates a list of one or more applications which are allowed to perform data communication in a disaster situation.

24. A node for a mobile network, the node comprising:
an interface for communication with a user equipment; and
a processor, the processor being configured to:
in response to detecting attachment of the user equipment to the mobile network, send a provisioning message to the user equipment;
wherein the provisioning message indicates a list of one or more applications which are allowed to perform data communication in a disaster situation,
wherein the processor is configured to perform steps of a method as defined in claim 1.

25. A user equipment, comprising:
an interface for connecting to a mobile network; and
a processor, the processor being configured to:
in response to the user equipment attaching to the mobile network, receive a provisioning message from the mobile network;
wherein the provisioning message indicates a list of one or more applications which are allowed to perform data communication in a disaster situation.

26. (canceled)
